(19) United States
(12) Patent Application Publication
(10) Pub. No.: US 2026/0280300 A1
(43) Pub. Date: Sep. 17, 2026

(54) DEMAND RESPONSE SYSTEM

(71) Applicant: NTT DOCOMO, INC., Tokyo (JP)

(72) Inventors: Yuta TOYAMA, Tokyo (JP); Masaki NAKAMURA, Tokyo (JP); Kazuhiko TAKENO, Tokyo (JP)

(73) Assignee: NTT DOCOMO, INC., Tokyo (JP)

(21) Appl. No.: 19/161,927

(22) PCT Filed: Mar. 7, 2024
(86) PCT No.: PCT/JP2024/008862

§ 371 Date: Sep. 3, 2025

(30) Foreign Application Priority Data
May 1, 2023 (JP) 2023-075724

(51) Int. Cl. H02J 3/32; B60L 1/00; G06Q 10/0631; H02J 3/17

(52) U.S. Cl. CPC H02J 3/322; B60L 1/006; G06Q 10/0631; H02J 3/17

(57) ABSTRACT

A demand response system includes a demand response reception unit that receives a notification of a DR request, an acquisition unit that acquires information regarding an electric mobility provided with a power source capable of supplying electric power externally, a cost calculation unit that calculates a cost required for the use of the power source provided in the electric mobility in response to the DR request received by the demand response reception unit based on the information acquired by the acquisition unit, and a determination unit that makes a determination regarding DR based on the cost calculated by the cost calculation unit.

### TECHNICAL FIELD

The present invention relates to a demand response (DR) system related to demand response.

### BACKGROUND ART

In recent years, with the surge in electricity prices and the like, adjustment of the supply and demand of electric power has become a significant issue. One method that can solve this issue is DR. This method is, for example, a mechanism in which, upon receiving a request to save electricity from an electric power company, a user saves electricity in response thereto and receives a reward as compensation (see, for example, Patent Literature 1).

### CITATION LIST

### Patent Literature

[Patent Literature 1] Japanese Unexamined Patent Publication No. 2022-173991

### SUMMARY OF INVENTION

### Technical Problem

Currently, electric vehicles, electric motorcycles, and electric kick scooters (stand-up electric scooters) and other electric mobilities are beginning to spread overseas, and it is expected that they will become widespread in Japan in the future. In such a society, it is also expected that rental services for electric mobilities and the like will become widespread. However, as a problem of such services, there is the issue of how to make effective use of the electric mobilities when they are not in use.

An embodiment of the present invention has been made in view of the above, and an object thereof is to provide a demand response system capable of effectively utilizing the electric mobilities by combining the electric mobilities with DR.

### Solution to Problem

To achieve the above-described object, a demand response system according to an embodiment of the present invention comprises: a demand response reception unit that receives a notification of a demand response request; an acquisition unit that acquires information on an electric mobility provided with a power source capable of supplying electric power externally; a cost calculation unit that calculates the cost necessary for the use of the power source provided in the electric mobility in response to the demand response request received by the demand response reception unit based on the information acquired by the acquisition unit; and a determination unit that makes a determination regarding the demand response based on the cost calculated by the cost calculation unit.

In the demand response system according to an embodiment of the present invention, the cost necessary for the use of the power source provided in the electric mobility in response to the DR request is calculated, and a determination regarding DR is made based on the calculated cost. As a result of this determination, in consideration of the above-described cost, the power source provided in the electric mobility can be used to respond to the DR request. That is, according to the demand response system of an embodiment of the present invention, the electric mobility can be effectively utilized by combining the electric mobility with DR.

### Advantageous Effects of Invention

According to an embodiment of the present invention, the electric mobility can be effectively utilized by combining the electric mobility with DR.

### BRIEF DESCRIPTION OF DRAWINGS

FIG. 1 is a diagram showing the configuration of a demand response system and related devices, etc., according to an embodiment of the present invention.

FIG. 2 is a graph for explaining an example of a DR mode.

FIG. 3 is a graph for explaining another example of a DR mode.

FIG. 4 is a flowchart showing processing executed in the demand response system according to an embodiment of the present invention.

FIG. 5 is a diagram showing the hardware configuration of the demand response system according to an embodiment of the present invention.

### DESCRIPTION OF EMBODIMENTS

Hereinafter, an embodiment of a demand response system according to the present invention will be described in detail with reference to the accompanying drawings. The same reference signs will be assigned to the same elements in description of the drawings and duplicate description will be omitted.

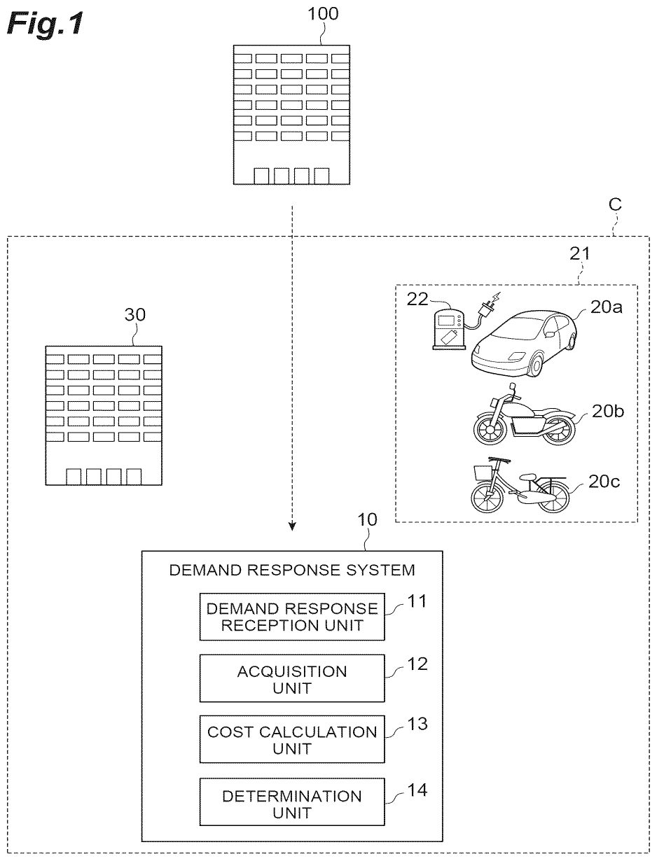

FIG. 1 shows a demand response system (demand response server) 10 according to the present embodiment. The demand response system 10 is a system (device) that makes determinations regarding DR for an electricity consumer C. For example, the demand response system 10 is owned by the consumer C. Alternatively, the demand response system 10 may be owned by an entity other than the consumer C and operate on behalf of the consumer C.

The consumer C has an electric mobility 20 (a general term for the electric mobilities 20a, 20b, and 20c). As shown in FIG. 1, the consumer C may have a plurality of electric mobilities 20. The electric mobility 20 is a mobile body, such as a vehicle, that moves using electric power. The electric mobility 20 is provided with a power source that supplies electric power for moving itself. The power source is, for example, a storage battery such as a battery, and supplies electric power charged from an external power source as power for moving itself. The electric mobility 20 is, for example, an electric vehicle 20a, an electric motorcycle 20b, and an electric bicycle 20c. The electric mobility 20 does not necessarily include all of the electric vehicle 20a, electric motorcycle 20b, and electric bicycle 20c, and may be only one kind among them. Further, the electric mobility 20 may be something other than the above, for example, an electric kick scooter.

The consumer C, for example, provides a rental service for the electric mobility 20. The consumer C stops and stores the electric mobility 20 at a storage location 21 for the electric mobility 20 provided in advance at a specific position. At the storage location 21, a charging device 22 capable of charging the power source provided in the electric mobility 20 is provided. A user of the rental service reserves and rents the electric mobility 20 by specifying the electric mobility 20 to be rented and the time (time period). The consumer C has a system for managing the rental of the electric mobility 20, including the above-described reservations. Note that the electric mobility 20 possessed by the consumer C may be used for purposes other than the rental service.

The power source provided in the electric mobility 20 is capable of supplying electric power externally. That is, the power source provided in the electric mobility 20 can supply electric power not only for moving itself but also for other purposes. Specifically, by connecting to a device (for example, a charging/discharging device) that receives electric power from the power source provided in the electric mobility 20 and discharging electric power to the device, electric power can be supplied externally from the power source.

The electric power supplied from the power source provided in the electric mobility 20 can be used in the same way as commercial power from a commercial power source. For example, in a facility (for example, in-house equipment) 30 such as a building owned by the consumer C, a device that receives electric power is provided, and the device receives electric power from the power source provided in the electric mobility 20, enabling the facility 30 to use this electric power for air conditioning and lighting. As the above-described electric mobility 20 and devices and systems related to the electric mobility 20, those similar to conventional ones can be used.

Further, in the facility 30 owned by the consumer C, commercial power from a commercial power source is supplied and used. The electric power company (electric utility) 100 that supplies commercial power from a commercial power source makes a DR request to the consumer C. Note that the DR request to the consumer C may be made by an entity other than the electric power company 100, such as an aggregator. The consumer C can use the power source provided in the electric mobility 20 to respond to the DR request. That is, the consumer C can utilize the electric mobility 20 as an energy source to respond to the DR request. To use the power source provided in the electric mobility 20, it is necessary to move the electric mobility 20 to the place where electric power is to be supplied in response to the DR request, for example, to the facility 30. The demand response system 10 makes determinations regarding the electric mobility 20 in relation to DR.

The demand response system 10 is constituted by a computer such as a PC (personal computer) or a server device having communication functions. The demand response system 10 may be constituted by a plurality of computers. The demand response system 10 has communication functions and may be able to mutually send and receive information to and from other devices. The demand response system 10 may be realized as one function of an EMS (Energy Management Service) server possessed by the consumer C.

Subsequently, the functions of the demand response system 10 according to the present embodiment will be described. As shown in FIG. 1, the demand response system 10 is configured to include a demand response reception unit 11, an acquisition unit 12, a cost calculation unit 13, and a determination unit 14.

The demand response reception unit 11 is a functional unit that receives a notification of a DR request. For example, when the electric power company 100 makes a DR request to the consumer C, it transmits a signal related to the request to the demand response system 10. The demand response reception unit 11 receives the notification of the DR request by receiving the signal. Further, the demand response reception unit 11 may receive the notification of the DR request by a method other than the above. For example, the above-described signal may be received by a device possessed by the consumer C other than the demand response system 10, and the demand response reception unit 11 may receive the notification of the DR request by receiving the signal from the device.

In the present embodiment, the DR requested from the electric power company 100 to the consumer C is for suppressing electric power demand, that is, a so-called downward DR. In DR, a time period subject to DR, i.e., the time period in which power demand is to be suppressed at the consumer C, is specified in advance. Further, in DR, an area or facility subject to DR, i.e., the area or facility in which the power demand is to be suppressed at the consumer C, may also be specified in advance. For example, in the present embodiment, the facility 30 is the facility subject to DR. Information indicating these is included, for example, in the signal related to the above-described request, and the demand response system 10 recognizes these by receiving the signal. Alternatively, information indicating these may be recognized in advance by the demand response system 10 by a method other than the signal related to the above-described request.

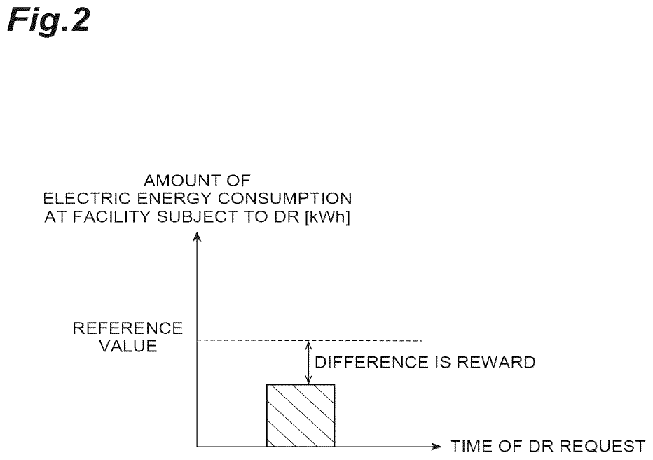

Further, in the present embodiment, the DR is incentive-based and is specifically either of the following two modes. In the first mode, as shown in FIG. 2, if the amount of electric energy consumption [kWh] at the facility subject to DR during the time period subject to DR (the time of the DR request) falls below a reference value, the consumer C can obtain a reward (DR incentive) as an incentive. In this case, the reward is an amount proportional to the difference between the reference value and the amount of electric energy consumption [kWh] at the facility subject to DR. That is, in this mode, the consumer C can obtain a reward corresponding to the amount of electricity saved.

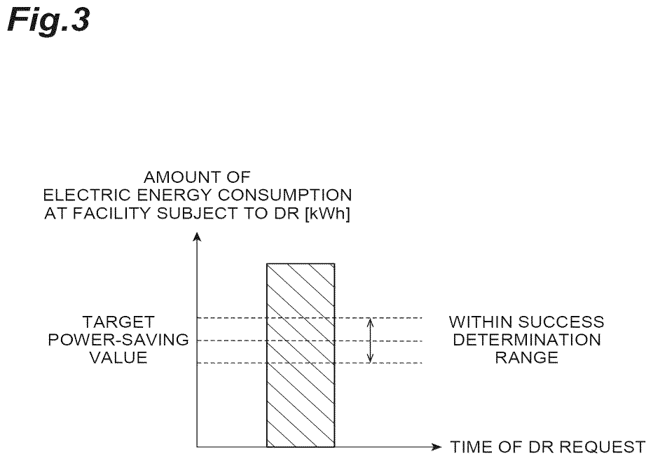

In the second mode, as shown in FIG. 3, if the amount of electric energy consumption [kWh] at the facility subject to DR during the time period subject to DR (the time of the DR request) falls within a certain range (for example, a success determination range within ±X percent of a target power-saving value (target power value)), the consumer C can obtain a reward as an incentive. The above-described certain range is usually a range smaller than the above-described reference value. In this case, the reward is a preset amount.

The reference value is the amount of electric energy from the electric power company 100 that would normally be expected to be used (the amount of electric energy from the electric power company 100 that the consumer C would have consumed) in the time period and area or facility where power demand is to be suppressed if the DR request had not been made. The reference value is calculated from the past power usage records at the consumer C, as in the conventional case, and is recognized by the electric power company 100 and the consumer C (demand response system 10). Each of the above-described DRs may be the same as in the conventional case.

The demand response reception unit 11 also acquires information related to the above-described DR. For example, the demand response reception unit 11 may acquire information included in the signal related to the request, or may acquire information by receiving input from the consumer C in advance. The demand response reception unit 11 outputs the fact that it has received the notification of the DR request and the acquired information to the following functional units according to the information.

The acquisition unit 12 is a functional unit that acquires information related to the electric mobility 20 provided with a power source capable of supplying electric power externally. The acquisition unit 12 may acquire information related to a plurality of electric mobilities 20. The acquisition unit 12 may acquire information related to the scheduled use of the electric mobility 20.

The information acquired by the acquisition unit 12 includes information used for calculating the cost necessary for the use of the power source provided in the electric mobility 20 in response to the DR request. The information used for calculating the cost is, for example, input in advance by the consumer C to the demand response system 10 and stored, and the acquisition unit 12 acquires it by reading out the stored information. If the consumer C possesses a plurality of electric mobilities 20, the acquisition unit 12 may acquire the information for each electric mobility 20. If there is information necessary for calculating the cost other than information related to the electric mobility 20, the acquisition unit 12 may acquire such information. The acquisition unit 12 outputs the acquired information necessary for calculating the cost to the cost calculation unit 13.

The information acquired by the acquisition unit 12 also includes information related to the scheduled use of the electric mobility 20. Such information is, for example, information on scheduled rentals of the electric mobility 20. Specifically, it is information on the presence or absence of scheduled rentals for each electric mobility 20 and for each time (time period). In this case, the acquisition unit 12 acquires such information from the system that manages the rental of the electric mobility 20. Further, information related to the scheduled use of the electric mobility 20 may be information other than the above as long as it indicates whether the electric mobility 20 can be used in response to the DR request. The acquisition unit 12 outputs the acquired information to the determination unit 14.

The acquisition unit 12, for example, acquires information and performs the acquisition and output of each of the above-mentioned pieces of information triggered by the demand response reception unit 11 receiving the notification of the DR request. However, provided that subsequent processing can be performed, the acquisition unit 12 may acquire and output each of the above-mentioned pieces of information at timings other than the above. Further, the acquisition unit 12 may acquire the above-described information by methods other than the above.

The cost calculation unit 13 is a functional unit that calculates the cost necessary for the use of the power source provided in the electric mobility 20 in response to the DR request indicated in the notification received by the demand response reception unit 11 based on the information acquired by the acquisition unit 12. The cost calculation unit 13 may calculate, as the cost, the cost of moving the electric mobility 20 to a location where electric power is to be supplied from the power source provided in the electric mobility 20 in response to the DR request.

The cost calculated by the cost calculation unit 13 is used for the determination regarding DR. For example, as will be described later, the cost is used for determining whether or not to use the electric mobility 20 in response to the DR request. Specifically, the cost is the moving cost of moving the electric mobility 20 to the location (in the present embodiment, the facility 30) where electric power is to be supplied from the power source provided in the electric mobility 20. However, the cost may be other than the above as long as it is used for the determination regarding DR.

The cost calculation unit 13, for example, calculates the moving cost as follows. The cost calculation unit 13 inputs information necessary for calculating the moving cost from the acquisition unit 12. The cost calculation unit 13 calculates the moving cost for each electric mobility 20 by the following formula stored in advance.

$$Moving cost [ yen ] = Moving distance [ km ] \times Electric energy consumption per distance [ Wh / km ] \times Electricity rate [ yen / Wh ]$$

The moving distance is the distance from the storage location 21 of the electric mobility 20 to the facility 30. Information indicating the moving distance may be acquired by the acquisition unit 12 as information used for calculating the cost. Alternatively, as information used for calculating the cost, the acquisition unit 12 may acquire information indicating the positions of the storage location 21 of the electric mobility 20 and the facility 30, and the cost calculation unit 13 may calculate the moving distance from such information.

The electric energy consumption per distance is the amount of electric energy required for the electric mobility 20 to travel a unit distance (1 km). The electricity rate is the electricity rate per unit electric energy (1 Wh) (required for charging the electric mobility 20). The electricity rate is usually the electricity rate for commercial power from the electric power company 100. This information may be acquired by the acquisition unit 12 as information used for cost calculation.

The cost calculation by the cost calculation unit 13 may be performed by a method other than the above as long as it is based on the information acquired by the acquisition unit 12. The cost calculation unit 13 outputs information indicating the calculated cost for each electric mobility 20 to the determination unit 14.

The determination unit 14 is a functional unit that makes a determination regarding DR based on the cost calculated by the cost calculation unit 13. The determination unit 14 may determine whether or not to move the electric mobility 20 to a location where electric power is to be supplied from the power source provided in the electric mobility 20 in response to the DR request based on the cost calculated by the cost calculation unit 13. The determination unit 14 may determine a combination of electric mobilities 20 that enables a response to the DR request from among a plurality of electric mobilities 20 and may determine, based on the cost calculated by the cost calculation unit 13 for each electric mobility 20 in the determined combination, whether or not to move each electric mobility 20 in the combination to a location where electric power is to be supplied from the power source provided in the electric mobility 20. The determination unit 14 may also make a determination regarding DR based on information related to the scheduled use of the electric mobility 20 acquired by the acquisition unit 12.

The determination unit 14, for example, makes a determination as follows. The determination unit 14 inputs information used for the determination from the demand response reception unit 11, the acquisition unit 12, and the cost calculation unit 13. The determination unit 14 determines, for each electric mobility 20, whether the electric mobility 20 can be used in response to the DR request based on the time period subject to DR indicated by the information input from the demand response reception unit 11 and the information related to the scheduled use of the electric mobility 20 input from the acquisition unit 12.

For example, the determination unit 14 detects the electric mobility 20 not scheduled for rental during the time period subject to DR as the electric mobility 20 that can be used in response to the DR request. The determination unit 14 determines that the electric mobility 20 scheduled for rental during the time period subject to DR cannot be used in response to the DR request. Since it is necessary to move the electric mobility 20 in response to the DR request, the determination may be made based on whether a rental is scheduled during a time period including a time period that goes back a preset length of time from the time period subject to DR. The determination unit 14 makes subsequent determinations for the electric mobility 20 determined to be available for use in response to the DR request. Note that the cost calculation by the cost calculation unit 13 may also be performed only for the electric mobility 20 determined to be available for use in response to the DR request.

Subsequently, the determination unit 14 makes a determination based on the cost calculated by the cost calculation unit 13. This determination corresponds to the mode of DR described above. The case of the first mode shown in FIG. 2 will be described. In this case, the electric power supplied from the electric mobility 20 to the facility 30, which is the facility subject to DR, during the time period subject to DR is assumed to contribute to the reduction in the amount of electric energy consumption by the facility 30 for which a reward is granted. That is, even if electric power is not supplied from the electric mobility 20, the amount of electric energy consumption by the facility 30 during the time period subject to DR is assumed to be below the reference value.

The determination unit 14 calculates, for each electric mobility 20, the amount of electric energy that can be supplied from the power source provided in the electric mobility 20 to the facility 30. For example, the determination unit 14 calculates as follows. In this case, the acquisition unit 12 acquires information indicating the charge amount of the power source of the electric mobility 20 at the time when the electric mobility 20 is used in response to the DR request (and is located at the storage location 21) as information related to the electric mobility. The determination unit 14 calculates the amount of electric energy required to move the electric mobility 20 to the facility 30, which is the facility subject to DR. For example, the amount of electric energy is calculated by moving distance [km]×electric energy consumption per distance [Wh/km]. The moving distance and electric energy consumption per distance may be those used for the cost calculation by the cost calculation unit 13. The determination unit 14 calculates the amount of electric energy that can be supplied to the facility 30 by subtracting the amount of electric energy required to move to the facility 30 from the charge amount of the power source of the electric mobility 20.

Subsequently, the determination unit 14 calculates, for each electric mobility 20, the reward in the case where electric power is supplied from the power source provided in the electric mobility 20 to the facility 30 during the time period subject to DR. For example, the determination unit 14 calculates the reward as the product of the amount of electric energy that can be supplied to the facility 30 and the reward per unit electric energy for reducing the power consumption.

The determination unit 14 compares, for each electric mobility 20, the cost indicated by the information input from the cost calculation unit 13 and the calculated reward. If the cost is less than the reward (cost <reward), the determination unit 14 determines to use the electric mobility 20 in response to the DR request. That is, the determination unit 14 determines to move the electric mobility 20 to the facility 30 and supply electric power from the power source provided in the electric mobility 20. If the cost is equal to or greater than the reward (cost ≥reward), the determination unit 14 determines not to use the electric mobility 20 in response to the DR request. That is, the determination unit 14 determines not to move the electric mobility 20 to the facility 30. In this way, the determination unit 14 makes a determination regarding the utilization of the electric mobility 20 in response to the DR request so that the reward is maximized (optimized) in consideration of the cost.

Further, the determination unit 14 may make a determination considering the limit on the number of electric mobilities 20 that can be used at the facility 30, and the maximum reducible amount of power consumption at the facility 30. For example, in such cases, the determination unit 14 determines to use, in response to the DR request, the electric mobility 20 for which the difference between the cost and the reward is large, in descending order, among the electric mobilities 20 determined to be used in response to the DR request.

Next, the case of the second mode shown in FIG. 3 will be described. In this case, it is assumed that all of the power reduced at the facility 30, which is the facility subject to DR, during the time period subject to DR is electric power supplied from the electric mobility 20. Therefore, in order to enable a response to the DR request, the total amount of electric energy supplied from the electric mobility 20 during the time period subject to DR is made to correspond to the difference between the reference value of the amount of electric energy consumption at the facility 30 and the success determination range.

The determination unit 14 calculates the difference between the reference value of the amount of electric energy consumption at the facility 30 and the success determination range. Information indicating the reference value of the amount of electric energy consumption at the facility 30 and the success determination range may be acquired, for example, by the demand response reception unit 11. Next, the determination unit 14 calculates, for each electric mobility 20, the amount of electric energy that can be supplied from the power source provided in the electric mobility 20 to the facility 30. This calculation may be performed in the same manner as in the case of the first mode.

Next, the determination unit 14 calculates a combination of electric mobilities 20 in which the total amount of electric energy that can be supplied from the power source provided in the electric mobility 20 to the facility 30 corresponds to the difference between the reference value of the amount of electric energy consumption at the facility 30 and the success determination range. That is, the determination unit 14 calculates a combination of electric mobilities 20 capable of realizing a reduction in electric energy that enables a response to the DR request (i.e., allows obtaining a reward). For example, the determination unit 14 calculates all combinations of electric mobilities 20, and for each combination, determines whether the total amount of electric energy that can be supplied from the electric mobilities 20 in the combination corresponds to the above-described difference, thereby calculating the combination.

Next, the determination unit 14 calculates the total cost indicated by the information input from the cost calculation unit 13 for each calculated combination. The determination unit 14 determines to use, in response to the DR request, the combination of electric mobilities 20 in which the total cost is the smallest among the calculated combinations. That is, the determination unit 14 determines to move the electric mobility 20 to the facility 30 and supply electric power from the power source provided in the electric mobility 20.

The determination unit 14 outputs the above-described determination result. For example, the determination unit 14 transmits information indicating the electric mobility 20 determined to supply electric power to the facility 30 in response to the DR request to a terminal of the consumer C. Alternatively, the determination unit 14 may output the above-described information in a form recognizable by the consumer C (for example, by display or voice output). The consumer C referring to the determination result from the determination unit 14 moves the electric mobility 20 to the facility 30 and supplies electric power to the facility 30 in response to the DR request. Alternatively, the determination unit 14 may transmit information indicating that movement to the facility 30 is necessary to the electric mobility 20 that has been determined to supply electric power to the facility 30 in response to the DR request. The electric mobility 20 may be moved in response to this transmission. The movement of the electric mobility 20 may be performed by autonomous driving. Further, the output of the determination result from the determination unit 14 may be performed by a method other than the above. The above describes the function of the demand response system 10 according to the present embodiment.

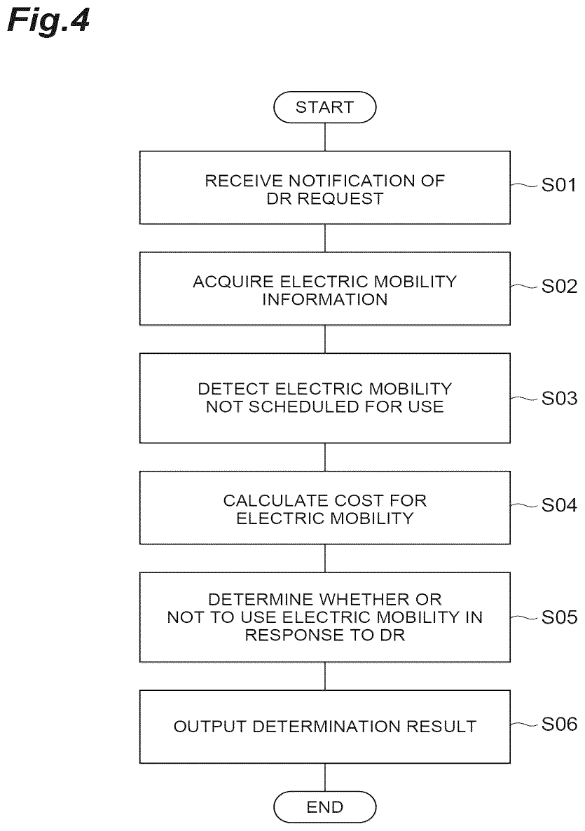

Next, using the flowchart of FIG. 4, processing executed by the demand response system 10 according to the present embodiment (operation method performed by the demand response system 10) will be described. This processing is performed when a DR request is made from the electric power company 100 to the consumer C.

In this processing, first, the demand response reception unit 11 receives a notification of the DR request (S01). Next, the acquisition unit 12 acquires information related to the electric mobility 20 (S02). The acquired information includes information used for calculating the cost necessary for using the power source provided in the electric mobility 20 in response to the DR request. Further, the acquired information also includes information related to the scheduled use of the electric mobility 20.

Next, the determination unit 14 detects the electric mobility 20 that is not scheduled to be used during the time period subject to DR based on the information acquired by the acquisition unit 12 (S03). The detected electric mobility 20 becomes a candidate for the electric mobility 20 to be used in response to the DR request. Next, the cost calculation unit 13 calculates the cost necessary for using the power source provided in the electric mobility 20 in response to the DR request (S04) based on the information acquired by the acquisition unit 12. For example, the above-mentioned moving cost is calculated as the cost.

Next, the determination unit 14 makes a determination regarding DR based on the cost calculated by the cost calculation unit 13 (S05). For example, as the determination, a determination is made as to whether or not to use the electric mobility 20 in response to the DR request. Next, the determination unit 14 outputs the determination result (S06). Based on this output, a corresponding action according to the determination result from the determination unit 14 is performed, for example, the electric mobility 20 is moved to the facility 30 in response to the DR request. The above describes the processing executed by the demand response system 10 according to the present embodiment.

In the present embodiment, the cost required for the use of the power source provided in the electric mobility 20 in response to the DR request is calculated, and a determination regarding DR is made based on the calculated cost. As a result of this determination, in consideration of the above-described cost, the power source provided in the electric mobility 20 can be used in response to the DR request. That is, according to the present embodiment, the electric mobility 20 can be effectively utilized by combining the electric mobility 20 with DR.

Further, as described above, the cost calculated by the cost calculation unit 13 may be the cost (moving cost) of moving the electric mobility 20 to the location (in the present embodiment, the facility 30) where electric power is supplied from the power source provided in the electric mobility 20 in response to the DR request. Also, the determination by the determination unit 14 may be a determination as to whether or not to move the electric mobility 20 to a location where electric power is supplied from the power source provided in the electric mobility 20 in response to the DR request. According to these configurations, as in the above-described embodiment, when it is necessary to move the electric mobility 20 in response to the DR request, the electric mobility 20 can be appropriately utilized.

Further, for example, in the case where the DR mode is the above-described second mode, the determination unit 14 may determine a combination of electric mobilities 20 that enables a response to the DR request from among a plurality of electric mobilities 20 and may make the above-described determination for the determined combination. According to this configuration, for example, in the case where the DR mode is the above-described second mode, the electric mobility 20 can be more appropriately utilized.

However, the cost calculated by the cost calculation unit 13 may be a cost other than the above-described moving cost as long as it is a cost required for the use of the power source provided in the electric mobility in response to the DR request. Also, the determination by the determination unit 14 may be other than the above-described determination as long as it relates to DR based on the cost calculated by the cost calculation unit 13.

Further, as described above, the determination by the determination unit 14 may also be made based on information regarding the scheduled use of the electric mobility 20. According to this configuration, for example, in the case where the electric mobility 20 is used for a rental service, the electric mobility 20 that is not rented during the time period subject to DR, that is, an idle electric mobility 20, can be appropriately utilized. However, information regarding the scheduled use of the electric mobility 20 need not be used in the determination by the determination unit 14.

Note that, in the above-described embodiment, the DR is a so-called downward DR, but the DR may also be a so-called upward DR, which creates power demand. In this case, for example, the DR request may be responded to by charging the electric mobility 20 at the facility 30.

In the block diagrams with reference to which the embodiment has been described, blocks of functional units are illustrated. Such functional blocks (component units) are realized by an arbitrary combination of at least one of hardware and software. In addition, a method for realizing each functional block is not particularly limited. In other words, each functional block may be realized by using one device that is combined physically or logically or using a plurality of devices by directly or indirectly (for example, using a wire or wirelessly) connecting two or more devices separated physically or logically. A functional block may be realized by one device or a plurality of devices described above and software in combination.

The functions include determining, deciding, determination, calculating, computing, processing, deriving, investigating, searching, ascertaining, receiving, transmitting, outputting, accessing, resolving, selecting, choosing, establishing, comparing, supposing, expecting, considering, broadcasting, notifying, communicating, forwarding, configuring, reconfiguring, allocating or mapping, and assigning, but are not limited thereto. For example, a functional block (constituent unit) enabling transmission to function is referred to as a transmitting unit or a transmitter. In either case, as described above, realization methods are not particularly limited.

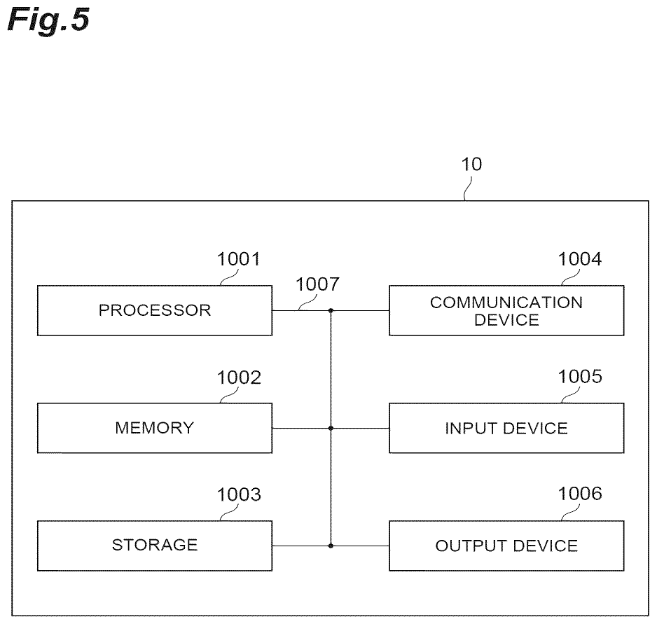

For example, the demand response system 10 in an embodiment of the present disclosure may function as a computer that performs information processing of the present disclosure. FIG. 5 is a diagram illustrating an example of a hardware configuration of the demand response system 10 according to an embodiment of the present disclosure. The above-described demand response system 10 may be physically configured as a computer device including a processor 1001, a memory 1002, a storage 1003, a communication device 1004, an input device 1005, an output device 1006, a bus 1007, and the like.

In addition, in the following description, a term “device” may be rephrased as a circuit, a device, a unit, or the like. The hardware configuration of the demand response system 10 may be configured to include one or a plurality of devices shown in the drawings, or may be configured without including some of the devices.

The processor 1001 performs an arithmetic operation by reading predetermined software (a program) onto hardware such as the processor 1001 or the memory 1002, and thus each function of the demand response system 10 is realized by controlling communication in the communication device 1004 or controlling at least one of reading-out and writing of data in the memory 1002 and the storage 1003.

The processor 1001, for example, controls the entire computer by operating an operating system. The processor 1001 may be configured as a central processing unit (CPU) including an interface with peripherals, a controller, an arithmetic operation unit, and a register. For example, each function in the above-described demand response system 10 may be realized by the processor 1001.

The processor 1001 reads a program (a program code), a software module, data, or the like from the storage 1003 and/or the communication device 1004 to the memory 1002 and performs various processes in accordance therewith. As the program, a program that causes a computer to perform at least some of the operations described above in the embodiment is used. For example, each function in the demand response system 10 may be realized by a control program which is stored in the memory 1002 and operates in the processor 1001. The various processes described above are described as being performed by a single processor 1001, but they may be simultaneously or sequentially performed by two or more processors 1001. The processor 1001 may be mounted as one or more chips. The program may be transmitted from a network via an electrical communication line.

The memory 1002 is a computer-readable recording medium and may be constituted by, for example, at least one of a read only memory (ROM), an erasable programmable ROM (EPROM), an electrically erasable programmable ROM (EEPROM), and a random access memory (RAM). The memory 1002 may be referred to as a register, a cache, a main memory (main storage device), or the like. The memory 1002 can store an executable program (program code), a software module, or the like that can be executed to perform information processing according to an embodiment of the present disclosure.

The storage 1003 is a computer-readable recording medium and may be constituted by, for example, at least one of an optical disc such as a compact disc ROM (CD-ROM), a hard disk drive, a flexible disk, a magneto-optical disc (for example, a compact disc, a digital versatile disc, or a Blu-ray (registered trademark) disc), a smart card, a flash memory (for example, a card, a stick, or a key drive), a floppy (registered trademark) disk, and a magnetic strip. The storage 1003 may be referred to as an auxiliary storage device. The storage medium included in the demand response system 10 may be, for example, a database including at least one of the memory 1002 and the storage 1003, a server, or another suitable medium.

The communication device 1004 is hardware (a transmitting and receiving device) that performs communication between computers via a wired and/or wireless network and is also referred to as, for example, a network device, a network controller, a network card, or a communication module.

The input device 1005 is an input device (for example, a keyboard, a mouse, a microphone, a switch, buttons, a sensor, or the like) that accepts an input from the outside. The output device 1006 is an output device (for example, a display, a speaker, an LED lamp, or the like) that performs output to the outside. In addition, the input device 1005 and the output device 1006 may have an integrated configuration (for example, a touch panel).

The devices such as the processor 1001 and the memory 1002 are connected to each other via the bus 1007 for transmission of information. The bus 1007 may be configured using a single bus, or may be configured using different buses between devices.

In addition, the demand response system 10 may be configured to include hardware such as a microprocessor, a digital signal processor (DSP), an application specific integrated circuit (ASIC), a programmable logic device (PLD), or a field programmable gate array (FPGA), or some or all of the respective functional blocks may be realized by the hardware. For example, the processor 1001 may be mounted using at least one of these types of hardware.

The order of processes, the sequences, the flowcharts, and the like of the aspects/embodiments described above in the present disclosure may be changed unless conflictions arise. For example, in the methods described in the present disclosure, various steps are described as elements of an exemplary order, but the methods are not limited to the described order.

Information or the like which is input or output may be stored in a specific place (for example, a memory) or may be managed using a management table. Information or the like which is input or output may be overwritten, updated, or added. The output information and the like may be deleted. The input information and the like may be transmitted to another device.

Determination may be performed using a value (0 or 1) which is expressed by one bit, may be performed using a Boolean value (true or false), or may be performed by comparison of numerical values (for example, comparison thereof with a predetermined value).

The aspects/embodiments described in this specification may be used alone, may be used in combination, or may be switched during implementation thereof. In addition, a notification of predetermined information (for example, a notification of being X) is not limited to be performed explicitly and may be performed implicitly (for example, a notification of the predetermined information is not performed).

As above, while the present disclosure has been described in detail, it is apparent to a person skilled in the art that the present disclosure is not limited to the embodiments described in the present disclosure. The present disclosure may be modified or changed without departing from the concept and the scope of the present disclosure set in accordance with the claims. Thus, the description presented in the present disclosure is for the purpose of exemplary description and does not have any limited meaning for the present disclosure.

It is apparent that software, regardless whether it is called software, firmware, middleware, a microcode, a hardware description language, or any other name, be widely interpreted to mean a command, a command set, a code, a code segment, a program code, a program, a subprogram, a software module, an application, a software application, a software package, a routine, a subroutine, an object, an executable file, an execution thread, an order, a function, and the like.

In addition, software, a command, information, and the like may be transmitted and received through a transmission medium. For example, when software is transmitted from a website, a server, or another remote source using at least one of wired technology (such as a coaxial cable, an optical fiber cable, a twisted-pair wire, or a digital subscriber line (DSL)) and wireless technology (such as infrared rays or microwaves), at least one of the wired technology and the wireless technology are included in the definition of a transmission medium.

The terms “system” and “network” used in the present disclosure are used interchangeably.

In addition, information, parameters, and the like described in the present disclosure may be expressed using absolute values, may be expressed using values relative to a predetermined value, or may be expressed using other corresponding information.

Terms such as “determining” used in the present disclosure may include various operations of various types. The “determining”, for example, may include a case in which judging, calculating, computing, processing, deriving, investigating, looking up, search, and inquiry (for example, looking up a table, a database, or any other data structure), or ascertaining is regarded as “determining”. In addition, “determining” may include a case in which receiving (for example, receiving information), transmitting (for example, transmitting information), input, output, or accessing (for example, accessing data in a memory) is regarded as “determining”. Furthermore, “determining” may include a case in which resolving, selecting, choosing, establishing, comparing, or the like is regarded as “determining”. In other words, “determining” includes a case in which a certain operation is regarded as “determining”. In addition, “determining” may be rephrased with “assuming”, “expecting”, “considering”, and the like.

The terms “connected” and “coupled” and every modification thereof refer to direct or indirect connection or coupling between two or more elements and can include that one or more intermediate element is present between two elements “connected” or “coupled” to each other. The coupling or connecting of elements may be physical, may be logical, or may be a combination thereof. For example, “connection” may be read as “access.” When used in the present disclosure, two elements may be considered as being mutually “connected” or “coupled” by using one or more wires and at least one of a cable and a print electric connection and, as several non-limiting and non-comprehensive examples, by using electromagnetic energy having wavelengths in a radio frequency region, a microwave region, and a light (both visible light and non-visible light) region.

The expression “based on” used in the present disclosure does not mean “based on only” unless otherwise described. In other words, description of “on the basis of” means both “only on the basis of” and “at least on the basis of”.

Any referring to elements, for which names of “first”, “second”, and the like are used, used in the present disclosure does not generally limit the amount or the sequence of such elements. The terms can be conveniently used to distinguish two or more elements in the present disclosure. Accordingly, referring to the first and second elements does not mean that only the two elements are employed therein or the first element precedes the second element in a certain form.

When the terms “include” and “including” and modifications thereof are used in the present disclosure, the terms are intended to have a comprehensive meaning similar to the term “comprising.” The term “or” used in the present disclosure is not intended to mean an exclusive logical sum.

In the present disclosure, for example, when an article such as a, an, or the in English is added in translation, the present disclosure may include a case in which a noun subsequent to the article is of a plural type.

In the present disclosure, a term “A and B are different” may mean that “A and B are different from each other”. The expression may mean that “A and B are different from C.” Expressions such as “separated” and “coupled” may be construed in the same way as “different.”

The demand response system of the present disclosure has the following configuration.
[1] A demand response system including:
   a demand response reception unit that receives a notification of a demand response request;
   an acquisition unit that acquires information regarding an electric mobility provided with a power source capable of supplying electric power externally;
   a cost calculation unit that calculates a cost required for the use of the power source provided in the electric mobility in response to the demand response request received by the demand response reception unit based on the information acquired by the acquisition unit; and
   a determination unit that makes a determination regarding demand response based on the cost calculated by the cost calculation unit.
[2] The demand response system according to [1], in which the cost calculation unit calculates, as the cost, a cost of moving the electric mobility to a location where electric power is supplied from the power source provided in the electric mobility in response to the demand response request.
[3] The demand response system according to [2], in which the determination unit makes a determination as to whether or not to move the electric mobility to a location where electric power is supplied from the power source provided in the electric mobility in response to the demand response request based on the cost calculated by the cost calculation unit.
[4] The demand response system according to [3], in which the acquisition unit acquires information regarding a plurality of electric mobilities, and
   the determination unit determines a combination of electric mobilities that enable a response to the demand response request from among a plurality of electric mobilities, and, based on the cost calculated by the cost calculation unit for each electric mobility in the determined combination, makes a determination as to whether or not to move each electric mobility in the combination to a location where electric power is supplied from the power source provided in the electric mobility.
[5] The demand response system according to any one of [1] to [4], in which the acquisition unit acquires information regarding the scheduled use of the electric mobility, and
   the determination unit makes a determination regarding demand response based also on the information regarding the scheduled use of the electric mobility acquired by the acquisition unit.

### REFERENCE SIGNS LIST

10 Demand response system, 11 Demand response reception unit, 12 Acquisition unit, 13 Cost calculation unit, 14 Determination unit, 20 (20a, 20b, 20c) Electric mobility, 21 Storage location, 22 Charging device, 30 Facility, 100 Electric power company, 1001 Processor, 1002 Memory, 1003 Storage, 1004 Communication device, 1005 Input device, 1006 Output device, 1007 Bus

1. A demand response system comprising circuitry configured to:
receive a notification of a demand response request;
acquire information regarding an electric mobility provided with a power source capable of supplying electric power externally;
calculate a cost required for the use of the power source provided in the electric mobility in response to the received demand response request based on the acquired information; and
make a determination regarding demand response based on the calculated cost.

2. The demand response system according to claim 1, wherein the circuitry calculates, as the cost, a cost of moving the electric mobility to a location where electric power is supplied from the power source provided in the electric mobility in response to the demand response request.

3. The demand response system according to claim 2, wherein the circuitry makes a determination as to whether or not to move the electric mobility to a location where electric power is supplied from the power source provided in the electric mobility in response to the demand response request based on the calculated cost.

4. The demand response system according to claim 3, wherein
the circuitry acquires information regarding a plurality of electric mobilities, and
determines a combination of electric mobilities that enable a response to the demand response request from among a plurality of electric mobilities, and, based on the calculated cost for each electric mobility in the determined combination, makes a determination as to whether or not to move each electric mobility in the combination to a location where electric power is supplied from the power source provided in the electric mobility.

5. The demand response system according to claim 1, wherein
the circuitry acquires information regarding the scheduled use of the electric mobility, and
makes a determination regarding demand response based also on the acquired information regarding the scheduled use of the electric mobility.
